(19) United States
(12) Patent Application Publication
(10) Pub. No.: US 2007/0096616 A1
(43) Pub. Date: May 3, 2007

(54) Vertical interconnection structure including carbon nanotubes and method of fabricating the same

(76) Inventors: In-Taek Han, Seoul (KR); Ha-Jin Kim, Suwon-si (KR); Sun-Woo Lee, Incheon-si (KR)

Correspondence Address: Robert E. Bushnell;Suite 300, 1522 K Street, N.W., Washington, DC, 20005, US

(21) Appl. No.: 11/544,918

(22) Filed: Oct. 10, 2006

(30) Foreign Application Priority Data
Nov. 2, 2005 (KR) 10-2005-0104359

(51) Int. Cl. H01J 1/02

(52) U.S. Cl. 313/309

(57) ABSTRACT

Provided are a vertical interconnection structure including carbon nanotubes and a method of fabricating the same. The vertical interconnection structure includes a substrate; a lower electrode formed on the substrate; a catalyst layer formed on the lower electrode; an inactivated catalyst layer covering the lower electrode and having a first hole exposing the catalyst layer; an insulating layer which is formed on the inert catalyst layer and has a second hole connected to the first hole; a plurality of carbon nanotubes grown from an exposed area of the catalyst layer by the first hole; an upper electrode on the insulating layer being electrically connected to the carbon nanotubes, the inactivated catalyst layer is formed through a thermal reaction between the catalyst layer covering the lower electrode except for the catalyst layer in the first hole and a passivation layer having a third hole corresponding to the second hole.

### CLAIM OF PRIORITY

This application makes reference to, incorporates the same herein, and claims all benefits accruing under 35 U.S.C. §119 from an application for VERTICAL INTERCONNECTION STRUCTURE USING CARBON NANOTUBE AND METHOD OF FABRICATING THE SAME earlier filed in the Korean Intellectual Property Office on 2 Nov. 2005 and there duly assigned Serial No. 10-2005-0104359.

### BACKGROUND OF THE INVENTION

1. Field of the Invention

The present invention relates to a vertical interconnection structure including carbon nanotubes and a method of fabricating the same.

2. Description of the Related Art

Normally, carbon nanotubes (CNTs) are cylindrical with a minute diameter of approximately a few nm (nanometers) and a very large aspect ratio of 10 to 1000. Carbon atoms in CNTs have a honeycomb arrangement, and each of the carbon atoms is coupled to three adjacent carbon atoms. CNTs can have conductor characteristics or semiconductor characteristics according to the structure thereof. Conductive CNTs have very high electrical conductivity.

CNTs have very high mechanical strength, a Young's modulus of tera digits, high thermal conductivity, etc. CNTs are applied to various technical fields such as field emission devices (FEDs), backlight units for liquid crystal display (LCD) devices, nanoelectronic devices, etc.

When conductive CNTs are used as vertical interconnections, a highly integrated circuit can be realized.

However, when the CNTs are used as vertical interconnections between an upper electrode and a lower electrode, the CNTs can cause a device failure because the carbon atoms diffuse in lateral directions during a growing process as illustrated in FIG. 1, and lift an insulating layer formed between the upper electrode and the lower electrode.

### SUMMARY OF THE INVENTION

The present invention provides a vertical interconnection structure having a catalyst layer for growing carbon nanotube in a limited region and a method of fabricating the same.

According to an aspect of the present invention, there is provided a vertical interconnection structure including carbon nanotubes, including a substrate; a lower electrode formed on the substrate; a catalyst layer formed on the lower electrode; an inactivated catalyst layer covering the lower electrode and having a first hole exposing the catalyst layer; an insulating layer which is formed on the inactivated catalyst layer and has a second hole connected to the first hole; a plurality of carbon nanotubes grown from an exposed area of the catalyst layer by the first hole; an upper electrode on the insulating layer being electrically connected to the carbon nanotubes, wherein the inactivated catalyst layer is formed through a thermal reaction between the catalyst layer covering the lower electrode except for the catalyst layer in the first hole and a passivation layer having a third hole corresponding to the second hole.

The catalyst layer may be formed of at least one metal selected from the group including Fe, Ni, Co, Y, Mo, Pd, and Pt.

The passivation layer may be Si, and the inactivated catalyst layer may be metal silicide.

The passivation layer may be formed of a metal selected from the group including W, Al, In, Zn, and Pb, and a stack including the lower electrode, the catalyst layer, and the passivation layer is an island insulated by the insulating layer.

The catalyst layer can have a thickness of 1 to 100 nm (nanometers).

The passivation layer can have substantially the same thickness as the catalyst layer, and the inactivated catalyst layer twice thicker than the catalyst layer.

The passivation layer can be composed of an oxide, a fluoride, a chloride, or a nitride formed through a reaction between the catalyst layer and an element selected from the group including oxygen, nitrogen, fluorine, and chlorine.

According to another aspect of the present invention, there is provided a method of fabricating a vertical interconnection structure including carbon nanotubes, including: forming a lower electrode on a substrate; sequentially forming a catalyst layer and a passivation layer covering the lower electrode on the substrate; forming an island stack including the lower electrode, the catalyst layer and the passivation layer; forming an insulating layer covering the island stack on the substrate; forming a via hole that exposes the catalyst layer by etching the catalyst layer and the passivation layer on the lower electrode; forming an inactivated catalyst layer by annealing the substrate to cause a thermal reaction between the catalyst layer and the passivation layer in a region that is not exposed by the via hole; growing carbon nanotubes from the catalyst layer exposed by the via hole; and patterning upper electrodes on the via holes.

The patterning of the upper electrodes may further include planarizing the insulating layer and the carbon nanotubes.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is a SEM image of carbon film diffused in a lateral direction on a catalyst layer during a growing process when the carbon nanotubes are used as a vertical interconnection between an upper electrode and a lower electrode;

FIG. 2 is a cross-sectional view of a vertical interconnection structure including carbon nanotubes according to an embodiment of the present invention;

FIGS. 3A through 3F are cross-sectional views illustrating a method of manufacturing a vertical interconnection structure including carbon nanotubes according to another embodiment of the present invention; and

FIG. 4 is a SEM image of carbon nanotubes vertically grown from a catalyst layer in a via hole of an insulating layer according to a method of growing according to an embodiment of the present invention.

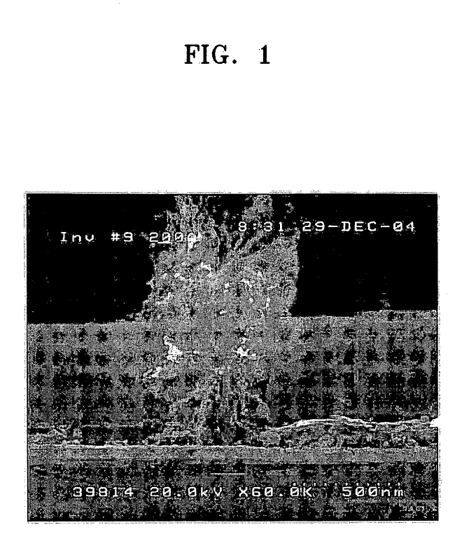

### DETAILED DESCRIPTION OF THE INVENTION

The present invention will now be described more fully with reference to the accompanying drawings in which exemplary embodiments of the invention are shown. In the drawings, the thicknesses of layers and regions are exaggerated for clarity. Like reference numerals refer to like elements throughout the drawings.

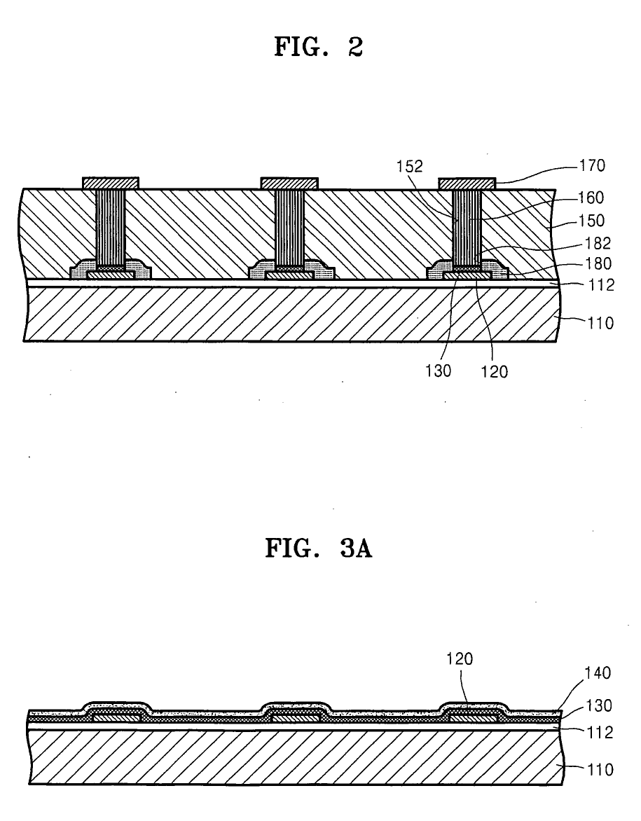

FIG. 2 is cross-sectional view of a vertical interconnection structure including carbon nanotubes according to an embodiment of the present invention.

Referring to FIG. 2, an insulating layer 112, for example, a silicon oxide (SiO₂) layer, having a thickness of 2000 Å (Angstrom) is formed on a silicon substrate 110. A lower electrode 120 is patterned on the insulating layer 112. The lower electrode 120 can be patterned into dots. A catalyst layer 130 is formed on the central part of the lower electrode 120. The catalyst layer 130 can be formed to a thickness of approximately 1 to 100 nm using a metal such as Fe, Co, Y, Mo, Pd, or Pt. The catalyst layer 130 is a catalyst layer for growing carbon nanotubes.

An inactivated catalyst layer 180 that surrounds the catalyst layer 130 is formed on the lower electrode 120. The inactivated catalyst layer 180 has a first hole 182 exposing the catalyst layer 130. The inactivated catalyst layer 180 is formed through a thermal reaction between the catalyst layer 130 covering the lower electrode 120 except the first hole 182 and a passivation layer (not shown) and covering the catalyst layer 130 except the first hole 182. The inactivated catalyst layer 180 will be described in more detail later.

An insulating layer 150, for example, a SiO₂ layer, having a second hole 152 connected to the first hole 182 and covering the inactivated catalyst layer 180, is formed on the silicon substrate 110. The first hole 182 and the second hole 152 form a via or through hole. Carbon nanotubes 160 grown from the catalyst layer 130 are formed in the via (through) hole. An upper electrode 170 electrically connected to the carbon nanotubes 160 is patterned on the insulating layer 150. The carbon nanotubes 160 are vertical electrical interconnections between the lower electrode 120 and the upper electrode 170.

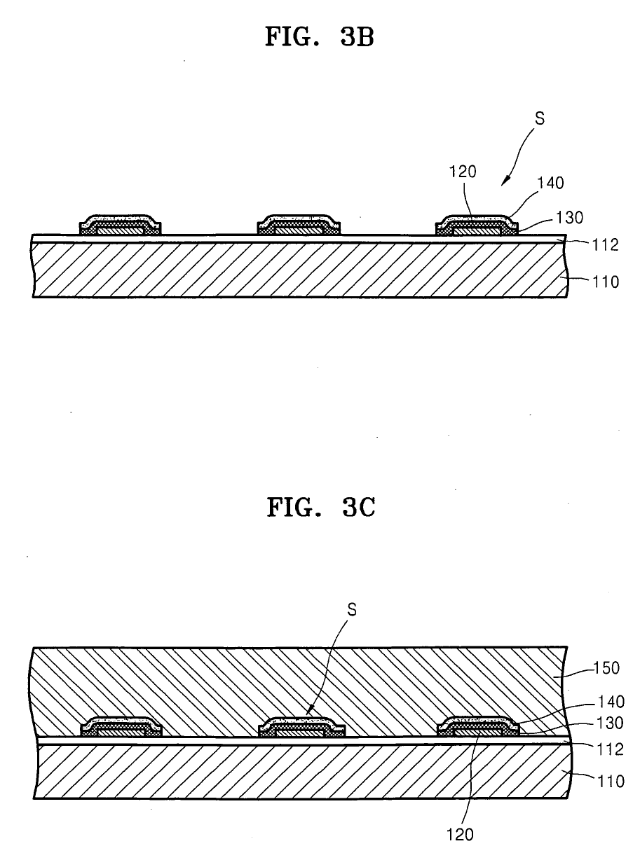

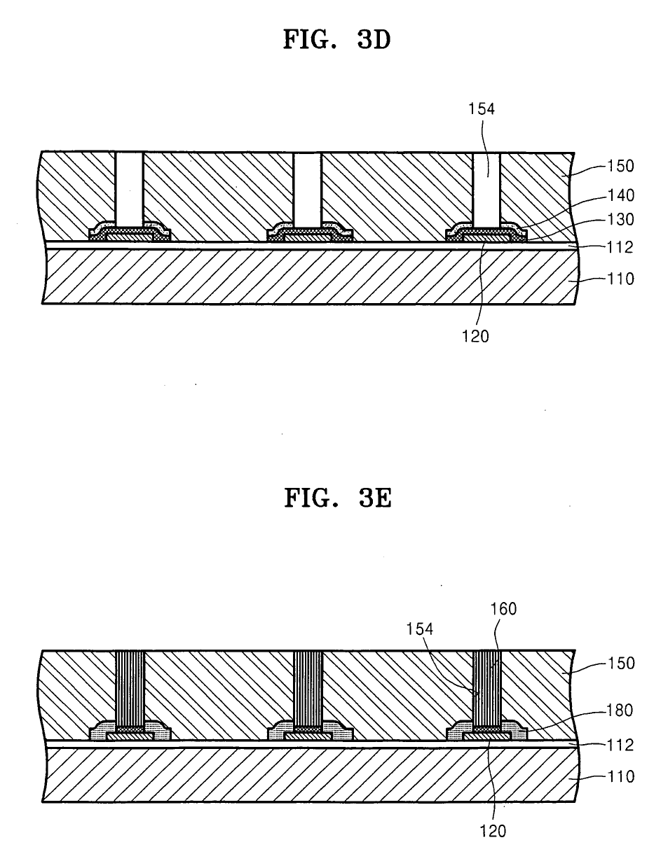

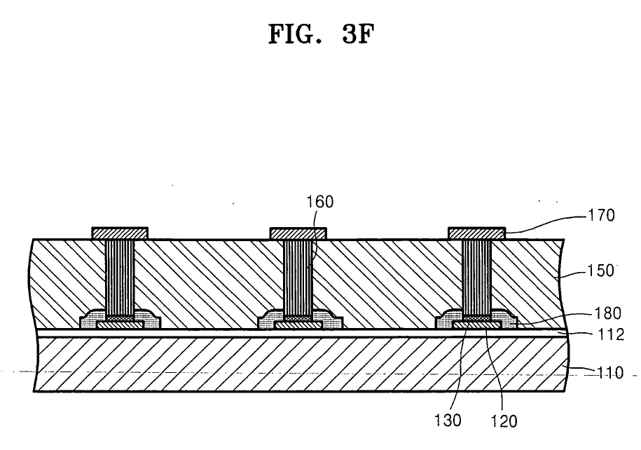

The passivation layer 140 (see FIG. 3) is formed to substantially the same thickness as the catalyst layer 130, and the inactivated catalyst layer 180 is formed to double the thickness of the catalyst layer 130. The passivation layer 140 forms the inactivated catalyst layer 180 through a thermal reaction with the catalyst layer 130 at a high temperature of, for example, 450° C. (celsius). The inactivated catalyst layer 180 prevents the carbon nanotubes 160 from growing underneath the insulating layer 150 during a carbon nanotube growing process.

The passivation layer 140 can be composed of silicon, in which case the inactivated catalyst layer 180 becomes metal silicide.

The passivation layer 140 can be a metal layer formed of a metal such as W, Al, In, Zn, or Pb. The lower electrode 120, the catalyst layer 130, and the passivation layer 140 may form islands insulated by the insulating layer 150.

The passivation layer 140 can be composed of an oxide, a fluoride, a chloride, or a nitride formed through a reaction between the catalyst layer 130 and an element selected from the group including oxygen, nitrogen, fluorine, and chlorine.

FIGS. 3A through 3F are cross-sectional views illustrating a method of fabricating a vertical interconnection structure including carbon nanotubes according to another embodiment of the present invention.

Referring to FIG. 3A, an insulating layer 112, for example, a SiO₂ layer, is formed to a thickness of 2000 Å (Angstroms) on a silicon substrate 110. After depositing a conductive layer (not shown), a lower electrode 120 is formed by patterning the conductive layer. The lower electrode 120 can be patterned into dots. Next, a catalyst layer 130 covering the lower electrode 120 is formed on the insulating layer 112. The catalyst layer 130 can be formed to a thickness of 1 to 100 nm (nanometers) using a metal such as Fe, Ni, Co, Y, Mo, Pd, or Pt. The catalyst layer 130 is a layer for growing carbon nanotubes.

Next, a passivation layer 140 is formed on the catalyst layer 130.

Referring to FIG. 3B, a stack “S” including the lower electrode 120, the catalyst layer 130, and the passivation layer 140 is formed by patterning the passivation layer 140 and the catalyst layer 130. The stack “S” is formed in islands to prevent an electrical short between the lower electrodes 120 via the catalyst layer 130 or the passivation layer 140.

Referring to FIG. 3C, an insulating layer 150, for example, a SiO₂ layer, covering the island stacks “S” is formed on the insulating layer 112.

Referring to FIG. 3D, via or through holes 154 are formed by etching the insulating layer 150 and the passivation layer 140 on the lower electrodes 120.

Referring to FIG. 3E, an inert catalyst layer 180 is formed by causing a reaction between the passivation layer 140 and the catalyst layer 130 contacting the passivation layer 140 through a thermal process of the silicon substrate 110.

The passivation layer 140 can be composed of silicon, in which case, the inactivated catalyst layer 180 becomes metal silicide. When the catalyst layer 130 is formed of Fe (iron), the inactivated catalyst layer 180 can be formed by annealing the silicon substrate 110 at a temperature of 450° C. (celsius) for one hour. The annealing condition can vary according to the materials composing and the thicknesses of the catalyst layer 130 and the passivation layer 140.

The passivation layer 140 can be a metal layer formed of W, Al, In, Zn, or Pb.

The passivation layer 140 can be composed of an oxide, a fluoride, a chloride, or a nitride formed through a reaction between the catalyst layer 130 and an element selected from the group including oxygen, nitrogen, fluorine, and chlorine.

Next, carbon nanotubes 160 are grown from the catalyst layer 130 exposed through the via or through hole 154 by injecting a carbon containing gas into a chamber where the silicon substrate 110 is placed. After the carbon nanotubes 160 are grown higher than the height of the via hole 154, the carbon nanotubes 160 can be formed to have the same height as the insulating layer 150 by planarizing the carbon nanotubes 160 using a chemical mechanical polishing (CMP) process.

Referring to FIG. 3F, after depositing a conductive layer (not shown) on the insulating layer 150, upper electrodes 170 covering the via holes 154 are formed by patterning the conductive layer.

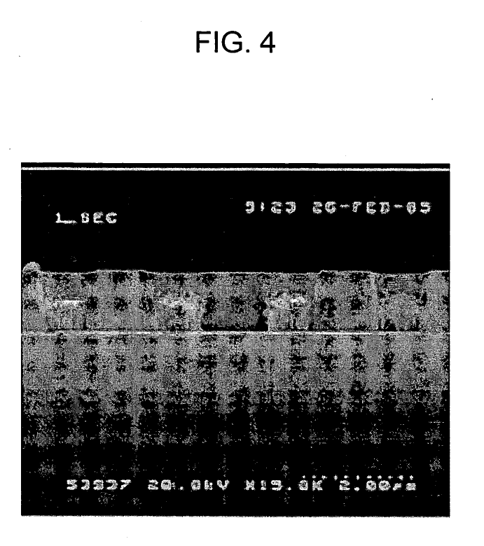

FIG. 4 is a SEM (scanning electron microscope) image of carbon nanotubes vertically grown from a catalyst layer in a via hole of an insulating layer according to the method of growing according to an embodiment of the present invention. Referring to FIG. 4, the catalyst layer that is not exposed through the via hole is an inactivated catalyst layer. Therefore, the carbon nanotubes 160 are not grown underneath the insulating layer.

The vertical interconnection structure according to the present invention provides favourable electrical characteristics since the vertical interconnection structure uses superior current transfer capabilities of the carbon nanotubes. Also, the vertical interconnection structure can be used for highly integrated circuits since the vertical interconnection is formed by a patterning technique.

In the method of fabricating the vertical interconnection structure including the carbon nanotubes according to the present invention, a catalyst layer can be aligned with a via or through hole, and a device yield can be increased by preventing the growing of the carbon nanotubes in regions other than the via hole since an inert catalyst layer is formed around the catalyst layer.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A vertical interconnection structure, comprising:
a substrate;
a lower electrode formed on said substrate;
a catalyst layer formed on said lower electrode;
an inactivated catalyst layer covering said lower electrode and including a first hole exposing said catalyst layer;
an insulating layer formed on said inert catalyst layer and including a second hole connected to the first hole;
a plurality of carbon nanotubes grown from an exposed area of said catalyst layer by the first hole;
an upper electrode on said insulating layer being electrically connected to said carbon nanotubes,
said inactivated catalyst layer is formed through a thermal reaction between said catalyst layer covering said lower electrode except for said catalyst layer in the first hole and a passivation layer having a third hole corresponding to the second hole.

2. The vertical interconnection structure of claim 1, wherein said catalyst layer is formed of at least one metal selected from the group consisting of Fe, Ni, Co, Y, Mo, Pd, and Pt.

3. The vertical interconnection structure of claim 2, wherein said passivation layer is comprised of Si, and said inert catalyst layer is composed of metal silicide.

4. The vertical interconnection structure of claim 2, wherein:
said passivation layer is formed of a metal selected from the group consisting of W, Al, In, Zn, and Pb, and
a stack including said lower electrode, said catalyst layer, and said passivation layer is an island insulated by said insulating layer.

5. The vertical interconnection structure of claim 1, wherein said catalyst layer has a thickness of 1 to 100 nm (nanometers).

6. The vertical interconnection structure of claim 5, wherein said passivation layer has substantially the same thickness as said catalyst layer, and said inert catalyst layer has twice the thickness of said catalyst layer.

7. The vertical interconnection structure of claim 2, wherein said passivation layer is comprised of an oxide, a fluoride, a chloride, or a nitride formed through a reaction between said catalyst layer and an element selected from the group consisting of at least one of oxygen, nitrogen, fluorine, and chlorine.

8. The vertical interconnection structure of claim 7, wherein a stack of said lower electrode, said catalyst layer, and said passivation layer is an island insulated by said insulating layer.

9. A method of fabricating a vertical interconnection structure, comprising:
forming a lower electrode on a substrate;
sequentially forming a catalyst layer and a passivation layer covering said lower electrode on said substrate;
forming an island stack including said lower electrode, said catalyst layer and said passivation layer;
forming an insulating layer covering said island stack on said substrate;
forming a hole that exposes said catalyst layer by etching said catalyst layer and said passivation layer on said lower electrode;
forming an inactivated catalyst layer by annealing said substrate to cause a thermal reaction between said catalyst layer and said passivation layer in a region that is not exposed by the hole;
growing carbon nanotubes from said catalyst layer exposed by the hole; and
patterning upper electrodes on a plurality of the holes.

10. The method of claim 9, wherein said forming of said catalyst layer comprises depositing at least one metal selected from the group consisting of Fe, Ni, Co, Y, Mo, Pd, and Pt on said substrate.

11. The method of claim 10, wherein said forming of said passivation layer comprises depositing silicon on said catalyst layer, and said inactivated catalyst layer is comprised of metal silicide.

12. The method of claim 10, wherein said forming of said passivation layer comprises depositing at least one metal selected from the group consisting of W, Al, In, Zn, and Pb on said catalyst layer.

13. The method of claim 9, wherein said catalyst layer is deposited to a thickness of 1 to 100 nm (nanometers).

14. The method of claim 13, wherein said passivation layer is deposited to include substantially the same thickness as said catalyst layer.

15. The method of claim 10, wherein:
said passivation layer is a compound layer containing an element selected from the group consisting of oxygen, nitrogen, fluorine, and chlorine, and
said forming of said inactivated catalyst layer comprises forming an inactivated catalyst layer formed of oxide, fluoride, chloride, or nitride through a thermal reaction between said passivation layer and said catalyst layer.

16. The method of claim 9, wherein said patterning of said upper electrode comprises planarizing said insulating layer and said carbon nanotubes.

17. A method of fabricating a vertical interconnection structure, comprising:
forming a lower electrode on a substrate;
sequentially in seriatim forming a catalyst layer and a passivation layer separately formed and completely covering said lower electrode on said substrate;
forming a separate stack of said lower electrode, said catalyst layer and said passivation layer;
forming an insulating layer covering entirely said stack on said substrate;
forming a hole exposing said catalyst layer;
forming an inactivated catalyst layer by annealing said substrate to cause a thermal reaction between said catalyst layer and said passivation layer in a region that is not exposed by the hole;
growing carbon nanotubes from said catalyst layer exposed by the hole; and
patterning an upper electrode on the hole.

18. The method of claim 17, wherein said forming of said inactivated catalyst layer by annealing being made at a certain temperature and a certain duration according to the materials and thickness of said catalyst layer and passivation layer.

19. The method of claim 17, wherein growing no carbon nanotubes underneath said insulating layer.

20. The method of claim 17, wherein said catalyst layer being aligned with the hole, where the hole includes a first hole in said inactivated catalyst layer exposing said catalyst layer, and a second separate hole in said insulating layer connected directly to the first hole, said carbon nanotubes having the same height as said insulating layer, and a second insulating layer being formed on said substrate and said lower electrode being patterned on said second insulating layer.
